(19) United States
(12) Patent Application Publication
(10) Pub. No.: US 2003/0211882 A1
(43) Pub. Date: Nov. 13, 2003

(54) Method and system for reconciling gaming machine jackpot and hopper fill slips

(75) Inventors: Robert L. Smith JR., Brigantine, NJ (US); Paul Jeffrey Bohrer, Margate, NJ (US)

Correspondence Address: SUGHRUE MION, PLLC, 2100 PENNSYLVANIA AVENUE, N.W., WASHINGTON, DC, 20037, US

(73) Assignee: ADAMAR OF NEW JERSEY, INC.

(21) Appl. No.: 10/141,990

(22) Filed: May 10, 2002

(51) Int. Cl. A63F 13/00

(52) U.S. Cl. 463/25

(57) ABSTRACT

A method and system for reconciling Slips, such as Jackpot Slips and Hopper Fill Slips. The method/system includes providing several Jackpot Slips, each containing a first original portion and a second original duplicate detachable portion, and each portion having the same unique machine readable symbol so each Slip can be uniquely identified. The first and second Slip portions are scanned to read the machine readable symbols to provide an inventory of the two portions. The inventories are then compared for any discrepancies.

### FIELD OF THE INVENTION

The present invention relates to a method and system for reconciling Gaming Machine Jackpot and Hopper Fill Slips, such as are used in Casino Slot Machines.

### BACKGROUND OF THE INVENTION

A Jackpot occurs when, for example, a Slot Machine player hits a certain combination of winning symbols on the Slot Machine. The Slot Machine can credit the player monies on the credit meter as slot credits for continuing play, or a Jackpot can be hand-paid by a slot attendant. There are two reasons why a jackpot must be hand-paid. One is when the amount of the Jackpot exceeds a certain dollar threshold within the computer chip of the Slot Machine, and the second is when the Jackpot amount meets or exceeds $1,200. Federal regulations mandate all Jackpots $1200 or above be paid manually and filed with the Internal Revenue Service with a W2G form.

A Hopper Fill is required when, for example, a slot player wants to cash out his/her credits and there is insufficient coins in the hopper within the Slot Machine to meet the pay-out. When this happens, the hopper must be refilled so the pay-out can be completed.

A slot attendant performs both of these transactions with the assistance of a slot cashier and a casino security guard.

Once the Slot Machine senses a Jackpot or a need for a Hopper Fill, a light on the Slot Machine will turn on in order to draw the attention of a slot attendant assigned to the area. The attendant will verify the need for the transaction and then proceed to a nearby Jackpot/Hopper Fill booth. The slot cashier will print the computer generated Jackpot or Hopper Fill Slip. Two forms are produced, an original and a carbon duplicate. The cashier and slot attendant will first sign both forms and then the attendant takes the funds (cash for a Jackpot, or a clear plastic bag of a fixed amount of coins or tokens, depending upon the denomination of the slot machine, to fill the slot's hopper) to the slot machine under the watchful eye of the casino security guard.

For example, several of the larger casinos have thousands of Slot Machines in different denominations ranging from nickels to $100 on its casino floor. These machines produce tens of thousands of Jackpot Slips and Hopper Fill Slips each month. Once the Jackpot and The attendant and the security guard return to the Slot Machine with the duplicate or carbon copy of the Slip and either pays the customer the jackpot or empties the hopper bag-into the Slot Machine. Once the transaction is complete, the guard signs the duplicate. The security guard maintains possession of the duplicate Slip until such a time occurs when he or she may deposit it into one of two locked boxes (one for Jackpots and another one for Hopper Fills) located at the Jackpot/Hopper Fill booth. The casino accounting department maintains the keys for the locked boxes and a casino accounting clerk collects the duplicate slips every morning for reconciliation. The slot cashier reconciles his or her bank using the original copies. The casino accounting department at the end of the gaming day then collects the original Jackpot and Hopper Fill Slips.

Reconciling the original and duplicate Slips is a tedious, time consuming task. Hopper Fill Slips reach the Casino Accounting Department, they must be separated from each other, and further separated by denomination, and then totaled on an adding machine. The original Jackpot and Hopper Fill Slips are already separated from each other by the Master Coin Bank of the Casino, but not subtotaled by denomination. These Jackpot and Hopper Fill Slips must be subtotaled by denomination by one of the casino accounting clerks. The present way this is done is by re-adding the Slips. The duplicate Slips collected from the locked boxes are a combination of both types of Slips and are not at all separated by denomination, let alone subtotaled.

Presently, this process consists of separating, by hand, the duplicate copies of the Jackpots from the Hopper Fills, further separating by hand by denomination and then subtotaling on an adding machine. This process lends itself to human error by the casino clerks in subtotaling the Slip amounts on the adding machine. Hopefully when complete, the subtotals of the duplicates agree with the subtotals of the originals. If not, and assuming any errors in adding the slips are corrected, then steps must be taken to identify those individual Slips that are missing. The process from start to finish can take numerous man-hours per day to complete for a large casino. The process must be performed because it is important to match the totals together to prevent theft. Duplicate Slips without the security guard's signature is one way for a Slot cashier and Slot attendant to steal from the casino.

In view of the shortcomings discussed above in connection with reconciling original and duplicate Jackpot and Hopper Fill Slips, it would be desirable to provide a method and system for reducing the human error and the time necessary to reconcile Jackpot and Hopper Fill Slips.

### SUMMARY OF THE INVENTION

It is therefore an object of the present invention to provide a method and system for increasing the accuracy and efficiency, and for reducing the overall time necessary to reconcile duplicate Slip forms.

It is another more particular object of the present invention to provide a method and system for increasing the accuracy and efficiency, and for reducing the overall time necessary to reconcile Jackpot and Hopper Fill Slips.

It is another object of the invention to provide a Slip, such as a Jackpot and Hopper Fill Slip that can be easily reconciled.

These and other objects of the invention are achieved with a method for reconciling original and duplicate Slips including, for example, Gaming Machine Slips, the method system comprising:

providing a plurality of Gaming Machine Slips, each Gaming Machine Slip comprising a first original portion and a second duplicate detachable portion, and each of the first and second portions having a same unique machine readable symbol so that each Gaming Machine Slip can be uniquely identified;

detaching the first and second portions of the Gaming Machine Slips;

subsequently collecting the detached first and second portions of the Gaming Machine Slips via independent collection paths;

separately scanning the first and second portions of the plurality of Gaming Machine Slips in order to read the machine readable symbols thereon to provide an inventory of first and second portions of the Gaming Machine Slips; and

comparing the inventories of the first and second Gaming Machine Slips for any discrepancies.

According to another aspect of the present invention, the above-identified objects are achieved by a Gaming Machine Slip, such as a Slot Machine Slip comprising:

a first portion and a second duplicate detachable portion, each of the first and second portions having printed thereon identifying information about the Gaming Machine, and each of the first and second portions having printed thereon the same unique machine readable symbol so that the two portions of the Gaming Machine Slip can be uniquely matched after the two portions are detached and separated from one another.

According to another aspect of the invention, the above-identified objects are achieved by a system for reconciling Slips, comprising:

a plurality of Gaming Machine Slips, each Gaming Machine Slip comprising a first original portion and a second duplicate detachable portion, and each of the first and second portions having a same unique machine readable symbol so that each Gaming Machine Slip can be uniquely identified; and

a high speed scanner for separately scanning the first and second portions of the plurality of Gaming Machine Slips in order to read the machine readable symbols thereon to provide an inventory of first and second portions of the Gaming Machine Slips; and

a software module for comparing the inventories of the first and second Gaming Machine Slips for any discrepancies.

### BRIEF DESCRIPTION OF THE DRAWINGS

FIG. 1 is a block diagram shown the system according to an embodiment of the invention.

FIG. 2 shows a gaming machine jackpot slip according to an embodiment of the invention.

FIG. 3 is a flow chart showing a routine according to an embodiment of the invention.

FIG. 4 is a flow chart showing a routine according to an embodiment of the invention.

### DESCRIPTION OF PREFERRED EMBODIMENTS

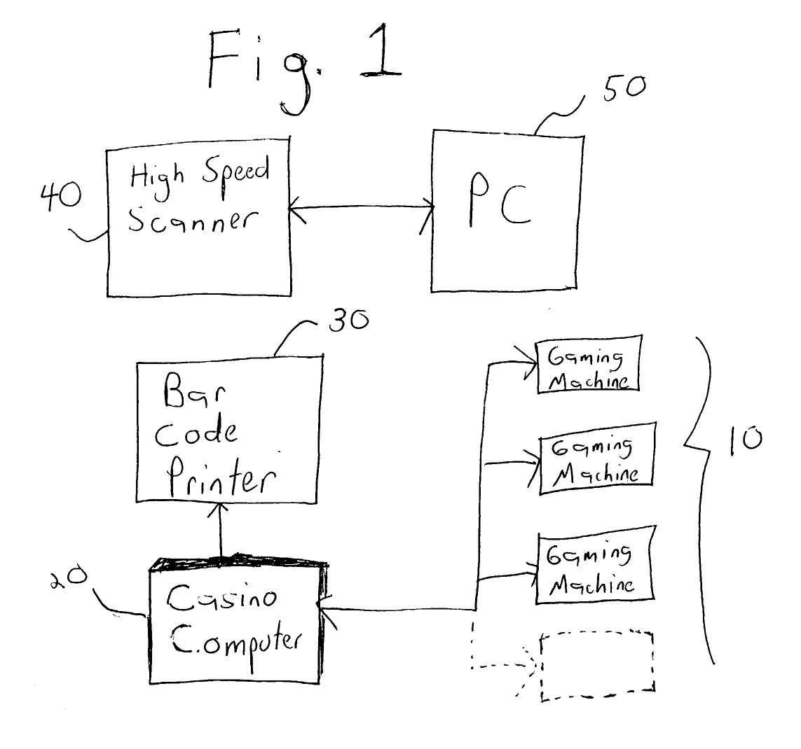

FIG. 1 is a block diagram showing a system according to an embodiment of the present invention. As shown in FIG. 1, the system includes a plurality of Casino Gaming machines 10, such as slot machines, a Casino Computer 20 connected in communication with the various Gaming Machines 10, and a Bar Code Printer 30, connected to receive outputs from the Casino Computer, for printing Jackpot and Hopper Fill slips with a machine readable symbol, such as a bar code. A suitable printer for printing bar codes according to an embodiment of the present invention is the Z6M printer manufactured by Zebra Technologies Corporation, Vernon Hills, Ill. The printer software may be written in Zebra Programming Language ZPL II which reprocesses the incoming data from the Casino Computer 20 and formats it for printing with a bar code. The system also includes a High Speed Bar Code Scanner 40 for scanning the barcode printed on the Jackpot and Hopper Fill Slips, and a PC 50, connected to the output of the Bar Code Scanner 40, for receiving information obtained from the scanned barcodes. A suitable scanner for use in connection with the present invention is the Multiscan MT-31 High Speed Scanner distributed by Currency Counting Consultants, Inc., King of Prussia, Pa., which is capable of scanning up to 1000 slips per minute.

The operation of obtaining and collecting Jackpot Slips according to an embodiment of the invention with now be described. When one of the Gaming Machines 10 awards a jackpot to a player, an electronic file of the jackpot is sent from the Gaming Machine to the Casino Computer 20. The Casino Computer 20 in turn transmits a request to the Bar Code Printer 30 to print the Jackpot Slip. The Printer 30 prints an Original Cashier Jackpot Slip and a Duplicate Security Jackpot Slip, each including the usual information presently provided on existing Jackpot Slips, such as the total Jackpot amount, the amount paid by the Gaming Machine 10, the Amount Paid by Hand, the identity and location of the Gaming Machine, a unique sequence number for the Jackpot Slip, the date and time of the Jackpot, and other identification information. According to an embodiment of the present invention, the Printer 30 also prints, besides the usual identification information discussed above, a machine readable code, such as a bar code, on both the Original Cashier and the Duplicative Security portions of the Jackpot Slip. The bar code contains the information printed on the Jackpot Slip, including a unique sequence number for the particular Jackpot Slip. This sequence number is later used to match corresponding Original Cashier and Duplicative Security Jackpot Slip portions.

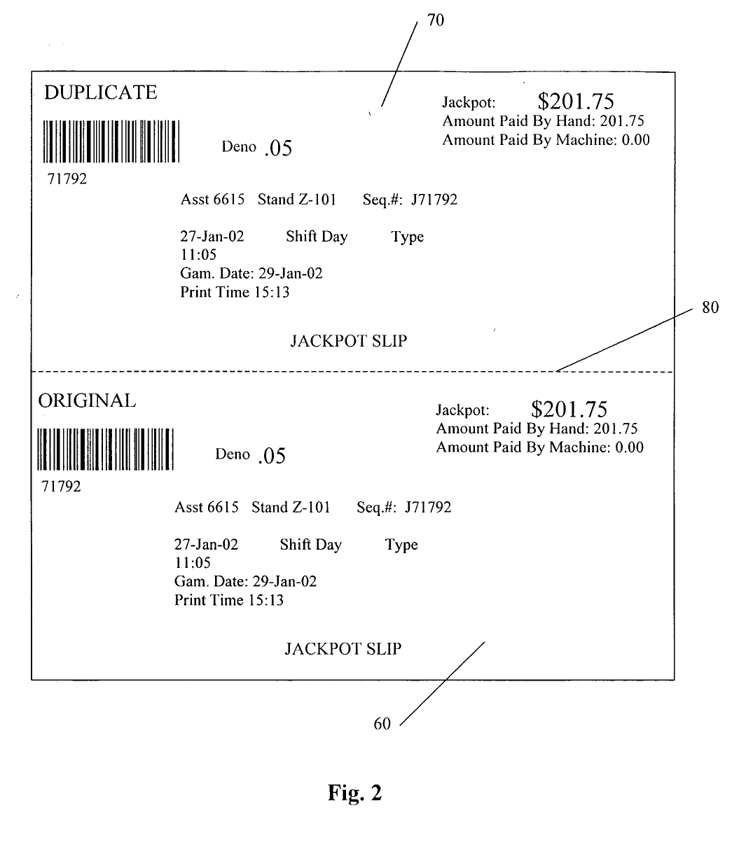

An example of a Jackpot Slip according to the invention is shown in FIG. 2. The Jackpot Slip shown in FIG. 2 includes an Original Cashier portion 60 and a Duplicative Security portion 70. These Original Cashier and Duplicative Security portions can be separated from one another by tearing along the lengthwise perforations 80 disposed between the two portions. The information on each portion of the Jackpot Slip includes the total Jackpot amount ($201.75), the amount paid by the Machine (0.00) and the amount paid by Hand ($201.75), the date and time of the Jackpot, the denomination (nickel) of the Gaming Machine, a unique sequence number for the Original Cashier and for the Duplicative Security portion (71792), and other identifying information. The information printed on the slips is also encrypted in the bar codes. As indicated above, a suitable printer for printing the Jackpots according to the invention is the Zebra Z6M printer.

According to casino regulations, the Original Cashier and Duplicate Security Jackpot or Hopper Fill Slips must be printed simultaneously. Ordinarily, casinos satisfy this requirement by using carbon paper when printing Jackpot and Hopper Fill Slips. However, bar codes are not easily transferred to the duplicate copy of carbon paper. Accordingly, it is necessary to program the printer software such that both the Original Cashier and Duplicate Security Slips are printed simultaneously. For example, the printer 30 may be equipped with inked ribbons to print the slips, and the printer software can be programmed to print both the original and duplicate security slips in a serpentine manner in order to satisfy the simultaneous printing requirement.

Once the Jackpot Slip is printed, the gaming machine attendant takes the Slip from the printer 30, and tears the Slip along the perforations 80 to separate the Original Cashier 60 and Duplicative Security 70 portions of the Slip. The attendant, his/her supervisor and one of the casino security guards signs both Slip portions, with the attendant retaining the Original Cashier portion, and the security guard retaining the Duplicative Security portion. The Gaming attendant then presents the Original Cashier Jackpot Slip portion 60 to a cashier for payment. The cashier retains the Original Cashier Jackpot Slip portion 60 and gives the attendant cash or a check in the amount specified by the Jackpot Slip. The attendant then gives the cash or check to the lucky player. As mentioned, the security guard retains the Duplicative Security portion 70 of the Jackpot Slip and returns this portion to the casino (e.g., in a designated lock box) for later reconciliation with the Original Cashier Jackpot Slip portion 60. At this point in the process, the casino should have in its possession the Original Cashier Jackpot slip portion 60 (from the cashier) as well as the Duplicate Security Jackpot slip portion 70 (obtained from the security guard).

A similar collection procedure occurs for obtaining Hopper Fill Slips. The Casino Computer 20 monitors the various Gaming Machines 10 within the casino, and determines when a particular machine 10 is low on coins (e.g., if the Computer 20 determines that a particular Machine 10 is at or below a predetermine threshold coin level). When Casino Computer 20 determines that a particular Gaming Machine 10 is low on coins, the Computer 20 sends a request to the Printer 30 to print a Hopper Fill slip. A request for Printer 30 to print a Hopper Fill Slip can also occur when an attendant determines that a particular machine needs to be filled (e.g., because a payout on a Jackpot is more than the amount of coins within the Machine 10). In either event, the Printer 30 prints a Hopper Fill Slip similar to the Jackpot Slip shown in FIG. 2. In particular, the Hopper Fill Slip will contain similar information to the Jackpot Slip shown in FIG. 2, such as the date and time of the Hopper Fill, a unique sequence number for the Original Cashier and Duplicative Security portions, the particular gaming machine being re-filled, the denomination, the total amount of the Hopper Fill, and other identifying information. In addition, according to an embodiment of the invention, both portions of the Hopper Fill Slip will also contain a bar code or other machine readable symbol, such as is shown in FIG. 2, containing this information. After Printer 30 prints the Original Cashier and Duplicative Security portions of the Hopper Fill Slip, the casino attendant takes the Slip to the cashier. The cashier retains the Hopper Fill Slip Cashier portion and pay-outs the amount in the denomination specified on the Hopper Fill Slip. A casino security guard retains the Duplicative Security portion of the Hopper Fill Slip. The attendant then fills the gaming machine witnessed by the attendant's supervisor as well as the casino security guard. As with the Jackpot Slip, the security later deposits the Duplicative Security portion of the Hopper Fill Slip to a locked box for subsequent reconciliation with the counterpart Original Cashier portion.

The process for reconciling collected Jackpot and Hopper Fill Slips will now be described.

At the end of a particular gaming date, casino personnel will gather both the Original Cashier and the Duplicate Security portions of the Jackpot/Hopper Fill Slips that were printed for that day. The Original Cashier and Duplicate Slip portions are then separately scanned in the High Speed Bar Code Scanner 40. The scanner is connected to a Personal Computer or PC 50 which contains reconciliation software according to an embodiment of the invention.

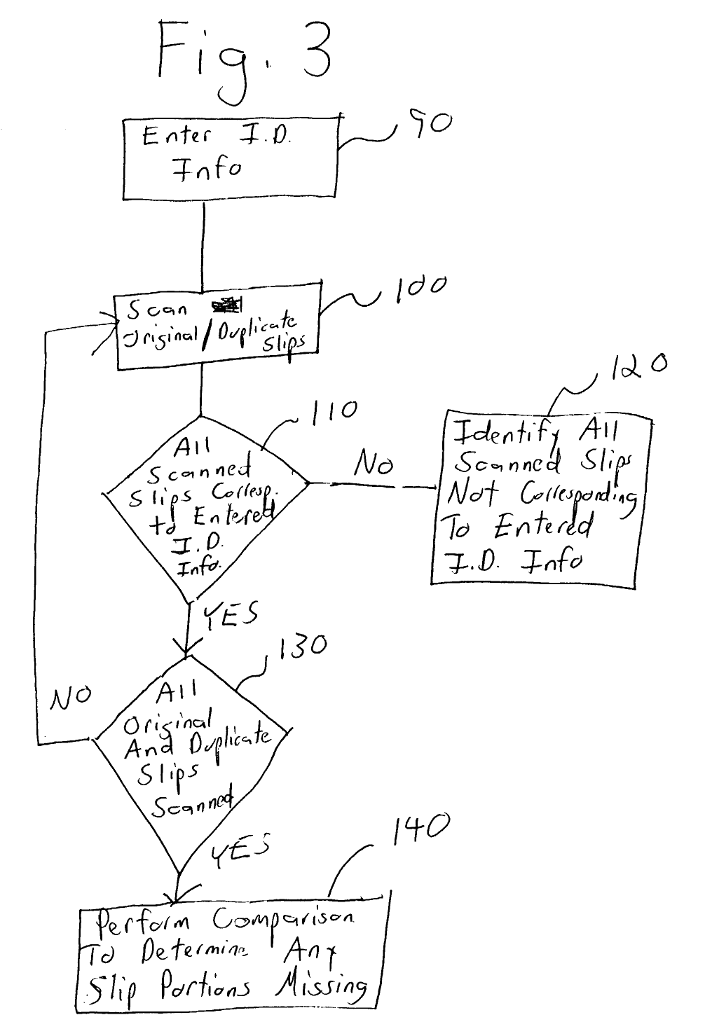

FIG. 3 is a flow chart describing the operation of the reconciliation process. As shown in FIG. 3, initially the user enters identification information in step 90 into the PC 50. For example, the user will enter information, such as: the gaming date to be reconciled, whether the Slips to be scanned by High Speed Bar Code Scanner 40 are Hopper Fill or Jackpot Slips, whether the Slips to be scanned are Cashier Original or Duplicate Security portions, and any other necessary identifying information, such as the denomination if, for example, Hopper Fill Slips are to be scanned. Next, the Slips are placed in the High Speed Scanner 40 and the bar code contained on each Slip is read in step 100. As mentioned above, Scanner 40 can scan as many as 1,000 Slips per minute. The software contained in PC 50 then determines whether all of the scanned Slips correspond to the identifying information entered by the user in step 110. This is determined by comparing the information obtained from the bar codes of each Slip with the identifying information entered by the user. For example, if the user entered identifying information representing a Duplicate Security Hopper Fill Slip, and an Original Cashier Jackpot Slip was inadvertently provided in the stack of Slips scanned by Scanner 40, then the Original Cashier Jackpot Slip is identified as not corresponding to the identifying information entered by the user in step 120. As indicative above, this is done by comparing the information obtained from the barcode of the Original Jackpot Slip with the user-entered information (which identifies that Duplicate Security Hopper Fill Slips are being scanned). The PC 50 can identify any Slips not corresponding to the user-entered identifying information in a variety of different ways. For example, the unique sequence number of those Slips not corresponding to the entered identifying information can be displayed to the user. The PC can also display information about each of the scanned slips, with an indication that a particular Slip does not correspond to the user-entered information. However, simply providing the sequence number of the non-corresponding Slips would still require the user to search through the stack of scanned Slips, which might number in the thousands, to retrieve the non-corresponding Slips. Therefore to reduce the time necessary to retrieve non-corresponding Slips, the PC 50 can display a list of all scanned slip sequence numbers, in scanned order, with any Slips not corresponding to the entered identifying information clearly highlighted to the user. This would provide a relative location of the non-corresponding Slips (i.e., a location relative to the stack of scanned Slips), thereby reducing the time necessary for the user to retrieve the non-corresponding Slips. That is, the user would be able to quickly locate the non-corresponding Slip(s) from the stack of scanned Slips.

While the example has been provided wherein an Original Cashier Jackpot Slip was inadvertently provided in a stack of Duplicate Security Hopper Fill Slips, it should be understand that the method shown in FIG. 3 would identify any other incorrect Slips provided in the stack (i.e., any Slips that do not correspond to the entered identifying information). Moreover, the Slips for Jackpot and Hopper Fill Slips can be devised such that a casino clerk can easily distinguish between Original Cashier and Duplicate Security portions of a Slip in order to reduce the possibility of mixing-in inappropriate slip portions in a given stack. For example, the Slips can be printed such that the Original Cashier and Duplicate Security portions have very different marks, fonts, characters or colors so that a casino clerk can readily determine whether a Original Cashier or a Duplicate Security Slip is in a wrong stack.

Once a stack of Slips is scanned, it is next determined whether or not all of the counterpart Slips have also been scanned in step 130. For example, if the Original Cashier Jackpot Slips for a particular day was scanned, but not the Duplicate Security Jackpot Slips, then the process proceeds back to step 100 where all of the Duplicate Security Jackpot Slips are next scanned after the user places the stack of these Slips onto the High Speed Bar Code Scanner 40. Once all of the Duplicate Security Jackpot Slips are scanned (step 100) and all non-corresponding Slips identified in step 120, then the method proceeds to step 140 wherein a comparison is performed between the scanned Slips to determine if any counterparts are missing. This comparison can be accomplished by comparing sequence numbers which are unique for each Jackpot and Hopper Fill Slip. That is, the same unique sequence number is assigned to the Original Cashier and Duplicate Security portions of a particular Slip. Similar to the way that non-corresponding Slips are identified in step 120, the PC can highlight any missing counterparts by sequence number so the user can easily retrieve that Original Cashier or Duplicate Security portion of the Slip that is contained in the stack.

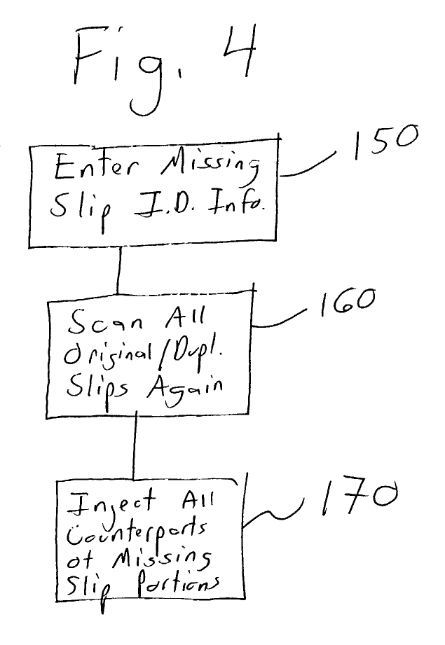

FIG. 4 is a flow chart showing an alternative routine for identifying the Original Cashier or Duplicate Security portion of the Slip that is contained in the stack after a missing counterpart Slip portion is identified. If, for example, after the comparison in step 140 of FIG. 3, the system determines that a single counterpart Duplicative Security Jackpot Slip is missing for a particular day, the user will then enter information representing the missing Slip in step 150. Next, the user will place the stack of all Original Cashier Jackpot Slips in the Scanner 40 so that the scanner can re-scan the barcodes contained on each Original Cashier Jackpot Slip in step 160. During the time each Slip is scanned, the routine compares the unique sequence number provided in each Slip's barcode with the missing sequence number entered by the user in step 150. Once a match is found between the entered missing sequence number and the scanned barcode sequence number, the PC 50 signals the Scanner 40 to eject the matched Original Cashier Slip portion in step 170. The user now has the counterpart of the missing Slip without any searching in the stack.

While the routine shown in FIG. 4 has been described in connection with retrieving a missing Slip, this same routine may also be used for purposes of retrieving a Slip inadvertently placed in a stack that does not correspond to the user entered identifying information. Specifically, in step 120 of FIG. 3, all scanned Slips that do not correspond to the user entered identifying information were identified. The identify of the non-corresponding Slip(s) could be entered in accordance with step 150 of FIG. 4, and the stack of Slips re-scanned as in step 160 so that the non-corresponding Slip(s) are ejected from the Printer 40. Alternatively, the routine can be programmed that upon identifying all scanned Slips not corresponding to the entered identifying information, the Scanner 40 automatically ejects the Slip(s) during the initial scan.

While specific embodiments have been described above, it should noted that the invention is not limited to these specific embodiments. For example, while all of the embodiments have been described in connection with reconciling Jackpot and Hopper Fill Slips, the invention is also applicable to other environments. For example, the present invention is equally applicable to situations in which tickets, vouchers, orders or forms having common identifying information, such as a sequence or serial number, must be reconciled.

What is claimed is:

1. A method of reconciling Gaming Machine Slips comprising:
providing a plurality of Gaming Machine Slips, each Gaming Machine Slip comprising a first original portion and a second duplicate detachable portion, and each of the first and second portions having the same unique machine readable symbol so that each Gaming Machine Slip can be uniquely identified;
detaching the first and second portions of the Gaming Machine Slips;
collecting the detached first and second portions via separate collection paths;
separately scanning the collected first and second portions in order to read the machine readable symbols thereon to provide an inventory of the first and second portions of each Gaming Machine Slip; and
comparing the inventories of the first and second Slip portions for any discrepancies there between.

2. The method according to claim 1, wherein the Gaming Machine Slip is a Jackpot Slip.

3. The method according to claim 2, wherein the Jackpot Slip is a slot machine Jackpot Slip.

4. The method according to claim 1, wherein the Gaming Machine Slip is a Hopper Fill Slip.

5. The method according to claim 4. wherein the Hopper Fill Slip is for a Slot Machine.

6. A Gaming Machine Slip, comprising:
a first portion and a second duplicate detachable portion, each of the first and second portions having printed thereon identifying information about the Gaming Machine, and each of the first and second portions having printed thereon the same unique machine readable symbol so that the two portions of the Gaming Machine Slip can be uniquely matched after the two portions are detached and separated from one another.

7. The Gaming Machine Slip according to claim 6, wherein the Gaming Machine Slip is a Slot Machine Slip.

8. The Gaming Machine Slip according to claim 7, wherein the Slot Machine Slip is a Jackpot Slip.

9. The Gaming Machine Slip according to claim 7, wherein the Slot Machine Slip is a Hopper Fill Slip.

10. The Gaming Machine Slip according to claim 6, wherein the machine readable symbol printed on the first and second portions includes symbols representing the printed identifying information so that the printed identifying information may be obtained from reading the machine readable symbols.

11. A system for reconciling Gaming Machine Slips, comprising
a plurality of Gaming Machine Slips, each Gaming Machine Slip comprising a first original portion and a second duplicate detachable portion, and each of the first and second portions having a same unique machine readable symbol so that each Gaming Machine Slip can be uniquely identified;
a machine readable scanner for separately scanning the first and second portions of the plurality of Gaming Machine Slips in order to read the machine readable symbols thereon to provide an inventory of first and second portions of the Gaming Machine Slips; and
a software module for comparing the inventories of the first and second Gaming Machine Slips for any discrepancies.

12. The system according to claim 11, wherein the Gaming Machine Slip is a Jackpot Slip.

13. The system according to claim 11, wherein the Gaming Machine Slip is a Hopper Fill Slip.

14. The system according to claim 12, wherein the Jackpot Slip for a Slot Machine.

15. The system according to claim 13, wherein the Hopper Fill Slip is for a Slot Machine.

16. The system according to claim 11, wherein said machine readable scanner is configured to eject a Gaming Machine Slip portion if said software module determines that a discrepancy exists for that Gaming Machine Slip portion.

17. The system according to claim 11, further comprising a display for displaying any discrepancy determined by said software module.

18. A system for providing Gaming Machine Slips, comprising:
a plurality of Gaming Machines;
a computer, connected in communication with said plurality of Gaming Machines;
a printer for printing a Gaming Machine Slip in response to a print command from said computer, said computer sending the print command when said computer determines that a Gaming Machine Slip should be printed for at least one of said Gaming Machines; said Gaming Machine Slip comprising a first original portion and a second duplicate detachable portion, and each of the first and second portions having the same unique machine readable symbol so that the Gaming Machine Slip can be uniquely identified.

19. The system according to claim 18, further comprising: a machine readable scanner for separately scanning the first and second portions of the Gaming Machine Slip in order to read the machine readable symbols thereon.

20. The system according to claim 18, wherein a plurality of Gaming Machine Slips are printed by said printer, and wherein said machine readable scanner reads the machine readable symbols on each of said Gaming Machine Slip portions to provide an inventory of first and second portions of the Gaming Machine Slips; and wherein said system further comprises a software module for comparing the inventories of the first and second Gaming Machine Slips for any discrepancies.
